(19) United States
(12) Patent Application Publication
(10) Pub. No.: US 2010/0082470 A1
(43) Pub. Date: Apr. 1, 2010

(54) METHOD FOR REMOTE CHECK DEPOSIT

(75) Inventors: Eugeniusz Walach, Haifa (IL); Tal Drory, Haifa (IL)

Correspondence Address: The Law Firm of Andrea Hence Evans, LLC, 14625 Baltimore Ave., #853, Laurel, MD, 20707, US

(73) Assignee: INTERNATIONAL BUSINESS MACHINES CORPORATION, ARMONK, NY (US)

(21) Appl. No.: 12/243,138

(22) Filed: Oct. 1, 2008

(51) Int. Cl. G06Q 40/00

(52) U.S. Cl. 705/35; 455/466

(57) ABSTRACT

A method and system for depositing a negotiable instrument, such as a check, using a cellular phone camera. The customer images the check for deposit by taking a photograph of the check with his cellular phone camera and sends the photograph as a MMS to the customer's bank. The system enables validating image quality, automatically recognizing code line, confirming geographical location of the deposit and verifying a courtesy amount of the check so that the check is deposited into the customer's bank account remotely.

### CROSS REFERENCE TO RELATED APPLICATIONS

None.

### FIELD OF THE INVENTION

The present invention relates to a method and system for remotely depositing checks using a cellular phone camera.

### BACKGROUND OF THE INVENTION

One of the most common business processes is that of check deposit. Unfortunately, this process is inconvenient and time consuming. Conventional procedure is to go to a human teller and wait in long lines. Another method of depositing checks is to use an overnight deposit (in the ATM) or direct deposit with check scanning performed in the ATM itself. Both methods require the physical presence of the depositor at the ATM machine.

The Check Clearing for the 21 st Century Act (Check 21) provides for depositing a check in an electronic form. The electronic check is the legal equivalent of the original check. For example, some banks allow the check image to be faxed to the bank for deposit. However, a fax machine must be available the depositor does not receive an immediate confirmation of the deposit.

### SUMMARY OF THE INVENTION

The present invention discloses a method and system for depositing a negotiable instrument, such as a check, using a cellular phone camera. The depositor images the check for deposit by taking a photograph of the check with his cellular phone camera and sends the photograph as a MMS to the depositor's bank. The system enables validating image quality, automatically recognizing code line and verifying a courtesy amount of the check so that the check is deposited into the customer's bank account.

It is an aspect of the present invention to provide a method and system of depositing a check without the depositor having to go to a bank or use an ATM machine.

It is another aspect of the present invention to provide a method and system of depositing a check that will provide lower operational costs for the bank since there will be less work for the tellers at the bank.

It is another aspect of the present invention to provide a method and system with geographical location verification of the depositor providing transaction security of the deposit.

### BRIEF DESCRIPTION OF THE DRAWINGS

FIG. 1 is block diagram demonstrating the issuer of the check enrolling in the check deposit service in accordance with the embodiments of the present invention.

FIG. 2 is a block diagram demonstrating the check depositing method in accordance with the embodiments of the present invention.

FIG. 3 is a block diagram demonstrating the bank processing the check image in accordance with the embodiments of the present invention.

### DETAILED DESCRIPTION OF THE INVENTION

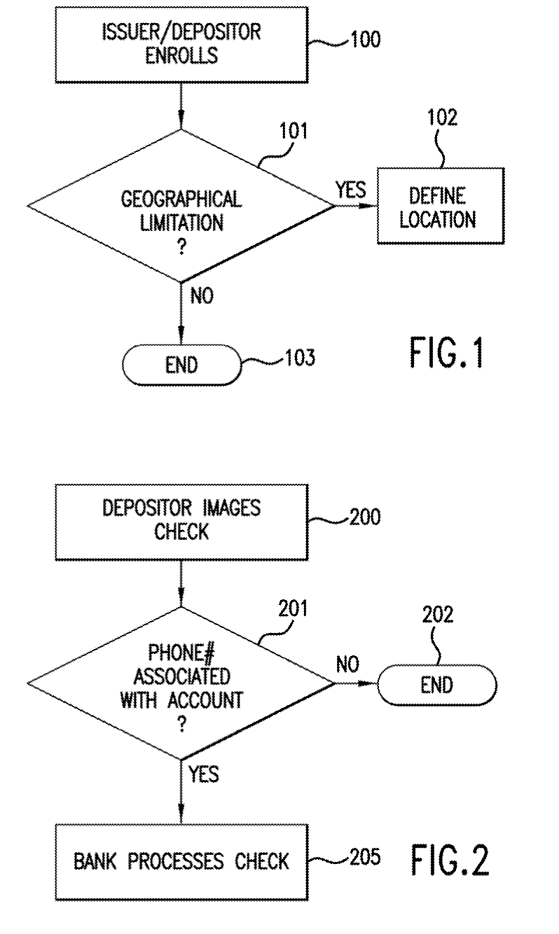

FIG. 1 is block diagram demonstrating the method of depositing a check in accordance with the embodiments of the present invention. The issuer of the check enrolls in the last deposit check program at 100. This program is a wireless deposit service. The issuer of the check is the individual or entity that drafts the check and whose account will be debited once the check is deposited. To enroll in this program, the issuer will open an appropriate banking account specifying all the security features (such as permission for on-line debit, allowable sums and locations, and phone numbers if SMS notification is required, and signature image if signature verification is requested.) As a security feature of the deposit program and as an option, the issuer may limit the geographical location as to where the check can be deposited at 101. If the issuer desires to limit the geographical location, the location must be defined at 102. The location may be limited to a specific list of places or locations. These locations may be defined by a geographical location, a city name, a specific store in a given city, local supermarket and the like. The list of locations is not meant to be exhaustive, as the geographical location can be numerous locations. If the issuer does not desire to limit the geographical location of where the depositor may remotely deposit the check, the depositor is not limited to a specific remote location and can deposit the check from the depositor's desired location. Once the issuer completes the enrollment process at 103, he can notify the depositor that he is enrolled in the program so then the depositor can proceed with enrolling in the program.

The check depositor also enrolls in the fast deposit check program at 100. The check depositor is the individual depositing the check and the check depositor's account will be credited with the check amount. The check depositor will enroll in the program with a fast deposit service provider, such as the check depositor's bank. The check depositor will answer a list of questions required for enrollment and associate his cell phone number and password with his account and himself. If the depositor has multiple bank accounts, an additional number can be used to differentiate between the accounts. Optionally, the check depositor may limit the allowed deposit locations at 101 by providing specific locations as to where he can deposit the check. Limiting the depositor's geographical location can help to prevent fraudulent activity. For example, if geographical location limitation is activated, the depositor is required to be at the specific geographical location or else the system will not allow the remote deposit of the check. Thus, if the depositors cell phone was stolen, he would not have to worry about someone trying to use his phone to deposit checks.

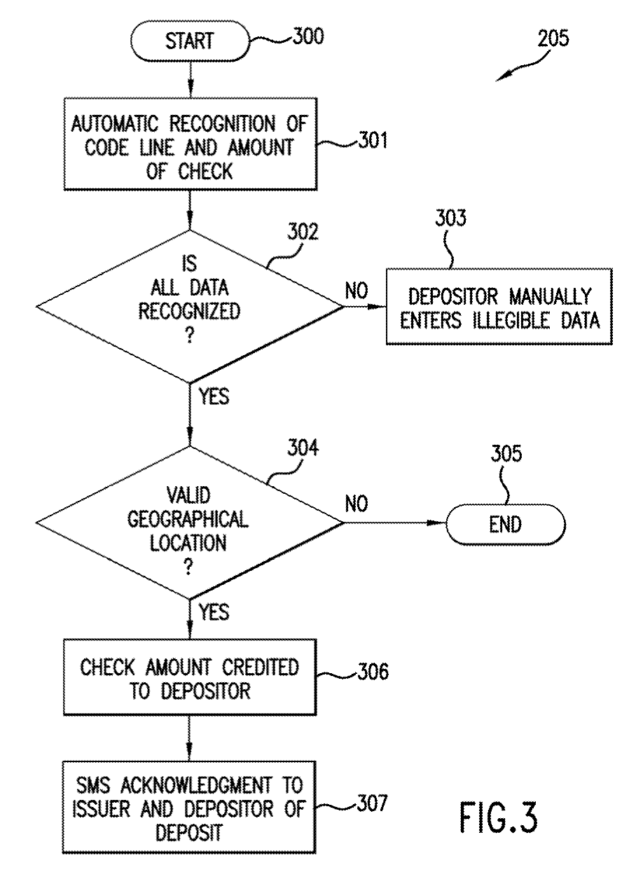

FIG. 2 is a block diagram demonstrating the cheek depositing method in accordance with the embodiments of the present invention. Once both the issuer of the check and depositor of the cheek have successfully enrolled into the deposit program at 100, the depositor can then begin to remotely deposit his checks as shown in FIG. 2. The depositor images the check at 200 with his cell phone camera. To image the check, the depositor aims his camera at the check and photographs the front of the check (optionally, if requested by the bank, both front and back can be imaged). Then, the depositor activates the deposit program by sending a MMS to the bank at a phone number assigned by the bank. This would be done by running appropriate application on the depositor's mobile device that would create message including both check image and geographical information (if mobile device is equipped with the GPS option). Activation of such program can be done via a conventional device menu. The program, run on the bank server, identifies the depositor's account to be credited with the funds in the given transaction at 201. To identify the depositors account, the program verifies that the phone number of the cell phone is the phone number the depositor associated with his account during the enrollment process. If the phone number does not match the number originally used for enrollment, the depositor is not allowed to proceed at 202. If the number is associated with the account, the system may ask the depositor for a password. This password is a number the depositor created during the enrollment process. He can use the keys on the cell phone to enter the password. Alternatively, the password may be a word or a combination of numbers and words. Once the password is confirmed by the program, the check is processed by the depositors bank at 205. The check process is described in more detail in FIG. 3.

FIG. 3 is a block diagram demonstrating the bank processing the check image in accordance with the embodiments of the present invention. The check image processing begins at 300 after it has been confirmed that the depositor's phone number is associated with the bank account. The program performs automatic recognition of the code line and the courtesy amount on the check at 301. The code line is check data located on the check, usually at the bottom of the check. The code line contains at least the bank account number and the check number. A character recognition engine can be used in order to recognize the code line. Typical OCR engines provide not only recognition values but recognition confidence as well. One can use the OCR engine to estimate the image quality at 302. If a certain percent of characters have a confidence below a certain threshold, the image quality is deemed to be poor. Other measures to determine image quality components may be used such as the image is binarized, connected components are found, black and white components under a certain size are detected and counted. If the number of components exceed a certain threshold, the image is deemed to be noisy or poor quality. If image quality is deemed poor, the depositor will be asked to re-image the device by using the camera on his cell phone to photograph the check.

Automatic signature verification would be performed, if required. This may be done by one of the existing algorithms/products designed for comparing signature image (as acquired form the check image) to the valid signature image kept in the bank data base). The check to be deposited is not required to be endorsed for the check deposit program. Endorsement is achieved automatically by identification of the phone number of the calling phone. If the number of the calling phone is identical to the number associated with the account, established during enrollment, endorsement of the check is satisfied.

If the image quality is deemed to be poor, the depositor will perform a semi-online manual data entry at 303. The characters that are not recognised will require a manual key-in. To enable this data entry process must be performed semi-online and with a minimal delay of a few seconds at most. A remote center will receive the data entry request from all the branches of the banks and provide this service. Only problematic information snippets would be sent for manual handling. An example of a problematic snippet is if the signature on the check descends into the code line area creating server interference with the OCR process. Remote center would serve combined key-in requests from all the bank customers. It would include quality assurance features (such as double key-in of the critical data) in order to reduce the possibility of error. In principle the system can function such that depositor would be asked to enter some data (e.g. courtesy amount) on the mobile device. However, in the preferred embodiment of this invention, all the data entry would be confined to the remote center increasing convenience and ease of use for both issuers and depositors.

As an added security feature, the program performs validation of the depositors location, if required by the issuer of the check or the depositor, at 304. The cell phone is equipped with a GPS system. Based on GPS data provided by the depositor's cell phone, the program confirms that the depositor is in the location required by the issuer of the check during enrollment or the location specified by the depositor. If the user is not at the required predetermined location, the program ends at 305. If the user is at the predetermined location, the check amount is credited to the depositor's account at 306. Once the check is credited, a performance acknowledgement message in the form of a SMS is sent to both the issuer of the check and the depositor of the check at 307 to the effect that the check processing is complete and that the check is ready for online money transfer or funds are available.

Alternatively, as an added security feature, the check owner can confirm that the check should be deposited or credited to the depositor's account. During enrollment, the check owner or issuer of the check would create a list of permitted locations that the check can be deposited. Examples of locations include but are not limited to the local school, or local grocery store. Also, the issuer can allow the checks to be cashed only during a certain time, such as business hours. The issuer of the check would allow the online money transfer or check deposit only if confirmed from the issuer's cell phone. The issuer of the check will acknowledge or approve the check to be deposited from the SMS message received. The conditions on usage such as the location or time, for example, would be analyzed by the program and the conditions must be met for deposit. This feature would prevent the depositing of forged or stolen cheeks because authorization from the account holder or issuer of the check is required for deposit.

A security feature is using a geographical location provided by the GPS system integrated into a number of cell phones. Using the GPS system in the cell phone, it can be determined that certain operations are limited to certain physical locations. For example, text to speech operation of library services would be disabled if accessed from a library location. However, the check issuer may not necessarily know the geographical locations of the shop where check deposit will take place (for example, check issuer may wish to permit check transactions in the local Wal-Mart stores, without necessarily knowing geographical coordinates of each store). A trusted central authority is created to maintain a list of logical locations and their geographical equivalents. Thus, service providers that require geographical location verification would send the verification request with the logical business name to the trusted authority via a secure link. The trusted authority will translate the logical name into the geographical location. The location would be returned to the service requester via a secure link and that geographical location would be used for verification purposes.

Although the term check has been used to describe an embodiment of an aspect of the present invention, other negotiable instruments for deposit, may be used within the scope of the invention.

The invention has been described in detail with particular reference to certain preferred embodiments thereof, but it will be understood that variations and modifications can be effected within the spirit and scope of the invention.

1) A method of a depositor depositing a check into a depositor account using a cell phone, the cell phone having a cell phone camera and a GPS system, the method comprising:
the issuer of the check and depositor of the check subscribing to a service that allows the check to be deposited by the cell phone;
taking an image of the check with the cell phone camera of the depositor;
sending the image as a MMS to a bank using the cell phone of the depositor,
wherein the bank verifies a cell phone number of the cell phone is associated with a bank account of the depositor;
using the GPS system to validate the depositor is located at a predefined location, wherein the predefined location is either a location established by the issuer of the check or a location established by the depositor;
processing the check by the bank so that an amount of the check is credited to the depositor account and
receiving a SMS from the bank on the cell phone confirming the check amount has been deposited into the depositor account.
